(19) United States
(12) Patent Application Publication
(10) Pub. No.: US 2010/0211887 A1
(43) Pub. Date: Aug. 19, 2010

(54) ONLINE LEGAL UTILITY

(76) Inventor: John Woollcombe, London (GB)

Correspondence Address: Walter J. Tencza Jr.,, Suite 210, 100 Menlo Park, Edison, NJ, 08837, US

(21) Appl. No.: 12/388,052

(22) Filed: Feb. 18, 2009

(51) Int. Cl. G06F 15/16; G06F 3/00

(52) U.S. Cl. 715/751; 709/205

(57) ABSTRACT

A web site server computer runs a computer software program which provides a web site, which is configured so that a first user can become a member of the web site by use of a first user computer. The web site can accept a first set of data uploaded from the first user computer to the web site. The web site sends an alert from the web site server computer to a second user computer of a second user, wherein the alert specifies that the first set of data can be downloaded to the second user computer if an agreement is entered into between the first user and the second user. The web site accepts an indication that the agreement has been entered into between the first user and the second user, and if the agreement has been entered into, the web site allows the second user to download the first set of data from the web site server computer to the second user computer.

### FIELD OF THE INVENTION

This invention relates to improved methods and apparatus concerning the confidential disclosure by one party to another of proprietary data and/or information and/or copyrighted works.

### BACKGROUND OF THE INVENTION

There are various devices known in the prior art for confidential disclosure of proprietary data and/or information and/or copyrighted works.

### SUMMARY OF THE INVENTION

One or more embodiments of the present invention provide a website that incorporates an online legal utility. The online legal utility may enable a first user to agree to terms with a second user through a secure and legal binding process to create a specific legal relationship between the two parties concerning proprietary data and/or information and/or copyrighted works including without limitation a binding confidential and/or non-disclosure legal relationship.

In one embodiment a method is provided including configuring a web site server computer so that it runs a computer software program which provides a web site, and configuring the web site so that a first user can become a member of the web site by use of a first user computer. The web site may be further configured so that the web site can accept a first set of data uploaded from the first user computer to the web site, and so that the web site sends an alert from the web site server computer to a second user computer of a second user, wherein the alert specifies that the first set of data can be downloaded to the second user computer if an agreement is entered into between the first user and the second user. The web site may be further configured so that it can accept an indication that the agreement has been entered into between the first user and the second user; and so that if the agreement has been entered into between the first user and the second user, the web site allows the second user to download the first set of data from the web site server computer to the second user computer.

The web site server computer may send a digital signature to the first user computer and to the second user computer when the agreement has been entered into. The web site may allow the second user a limited period of time to download the first set of data from the web site server computer to the second user computer. The web site server may provide a first user interface to the first user computer. The first user can use the first user interface to upload the first set of data. The web site server may provide a second user interface to the second user computer, wherein the second user can use the second user interface to enter into the agreement with the first user and to download the first set of data if the agreement is entered into with the first user.

The agreement may be a confidentiality agreement through which the second user agrees to keep the first set of data confidential. The method may further include storing the agreement after it has been entered into in a computer memory; and storing an indication that the first user and the second user have entered into the agreement in the computer memory. The computer memory may be located on the web site server computer.

### BRIEF DESCRIPTION OF THE DRAWINGS

FIG. 1 shows a diagram of an apparatus for use in accordance with an embodiment of the present invention;

FIGS. 2A-B shows a flow chart of a method in accordance with an embodiment of the present invention;

FIG. 3 shows a diagram of a first image which may be displayed on a computer monitor of a first user computer of the apparatus of FIG. 1;

FIG. 4 shows a diagram of a second image which may be displayed on a computer monitor of the first user computer of the apparatus of FIG. 1;

FIG. 5 shows a diagram of a third image which may be displayed on a computer monitor of the first user computer of the apparatus of FIG. 1; and

FIG. 6 shows a diagram of a fourth image which may be displayed on a computer monitor of the first user computer of the apparatus of FIG. 1.

FIG. 7 shows a diagram of a fifth image which may be displayed on a computer monitor of first user computer of the apparatus of FIG. 1;

FIG. 8 shows a diagram of a sixth image which may be displayed on a computer monitor of the first user computer of the apparatus of FIG. 1;

FIG. 9 shows a diagram of a seventh image which may be displayed on a computer monitor of the second user (or recipient) computer of the apparatus of FIG. 1;

FIG. 10 shows a diagram of an eighth image which may be displayed on a computer monitor of the second user (or recipient) computer of the apparatus of FIG. 1;

FIG. 11 shows a diagram of a ninth image which may be displayed on a computer monitor of the second user (or recipient) computer of the apparatus of FIG. 1; and

FIG. 12 shows a diagram of a tenth image which may be displayed on a computer monitor of the second user (or recipient) computer of the apparatus of FIG. 1;

FIG. 13 shows a diagram of an eleventh image which may be displayed on a computer monitor of the second user (or recipient) computer of the apparatus of FIG. 1;

FIG. 14 shows a diagram of a twelfth image which may be displayed on a computer monitor of the first user computer of the apparatus of FIG. 1;

FIG. 15 shows a diagram of a thirteenth image which may be displayed on a computer monitor of the first user computer of the apparatus of FIG. 1;

### DETAILED DESCRIPTION OF THE DRAWINGS

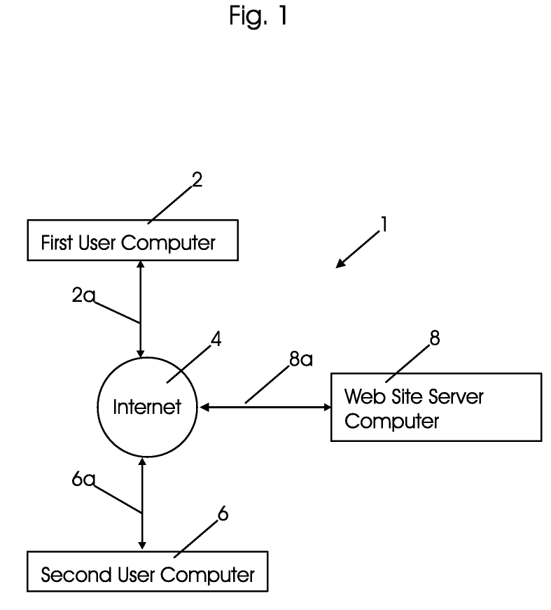

FIG. 1 shows a diagram of an apparatus 1 for use in accordance with an embodiment of the present invention. The apparatus 1 includes a first user computer 2, the internet 4, a second user computer 6, and a web site server computer 8. The first user computer 2 may be used by a first user, and the second user computer 6 may be used by a second user. The first user computer 2, the second user computer 6, the web site server computer 8 are in communication with the internet via communications links 2a, 6a, and 8a, respectively. The internet 4 may include any communications links, such as wireless or wired, optical, and/or any other communications links which may be part of the internet or the world wide web. Each of the first user computer 2, the second user computer 6, and the web site server computer 8 may have a computer processor, a computer display or monitor, a computer memory, and an interactive device or devices such as a computer mouse and/or a computer keyboard.

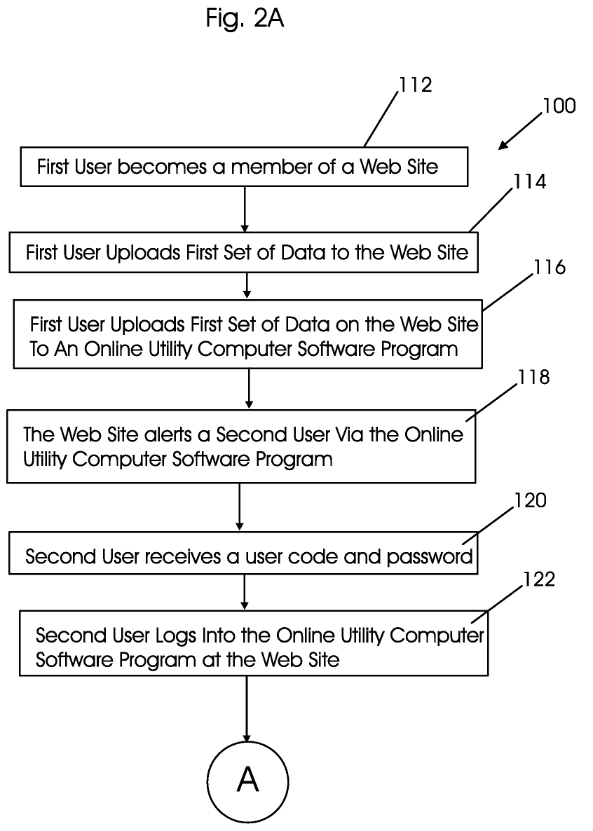

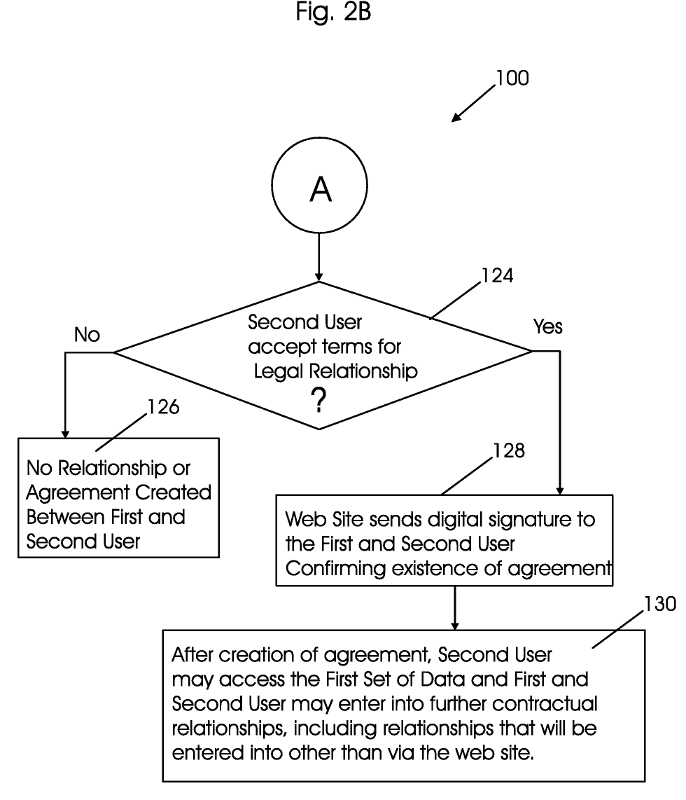

FIG. 2 shows a flow chart 100 of a method in accordance with an embodiment of the present invention. At step 112 a first user becomes a member of a web site, which may be defined or determined by computer software running on the web site server computer 8 shown in FIG. 1. Typically the first user would become a registered member user of the web site by using a computer mouse or keyboard of the first user computer 2 to register on the web site provided on the internet 4 by web site server computer 8. Using a keyboard or computer mouse of the first user computer 2, the first user would provide certain details to the web site server computer 8 for the purposes of identification of the first user. In some embodiments of the present invention, it may not be necessary for the first user to become a member of the web site, and step 112 may be eliminated.

At step 114, the first user uploads a first set of data from the first user computer 2 to the internet 4 and then to the web site server computer 8. The first set of data may include data and/or information and/or digital works. The first set of data may be information or data which the first user desires to be accessed by a second user, and which the first user wants to be subject to an agreement between the first and the second user. The first user, such as at first user computer 2, may upload a first set of data such as a copyrighted work and in at least one embodiment of the present invention the first user will receive a digital signature by e-mail to the first user's e-mail address confirming that the first user has registered the work at the website or web site server computer 8 on the date and time it is uploaded for future reference and protection.

At step 116 the first user uploads the first set of data from the website to the online legal utility which, in at least one embodiment is a computer program running on the website that is only available for use by registered members. In at least one embodiment, the first user must know the identity of the second user and at the time of uploading the first set of data to the online legal utility the first user must, in addition to uploading the first set of data, must upload contact details of the second user. The contact details of the second user may include the second user's email address. The first set of data and the contact details of the second user may be uploaded to the web site or the web site server computer 8. At step 118 the website server computer 8 prompted by the operation of the online legal utility computer program, typically running on the website server computer 8, alerts the second user and/or second user computer 6 via e-mail, online, and/or digitally concerning the opportunity for the second user to enter into an agreement with the first user in connection with the first set of data. An alert message and/or signal prompted by the operation of the online legal utility computer program running on the website server computer 8 may be sent by the web site server computer 8 to the second user computer 6 via the internet 4.

At step 120, the second user receives a user code and a password at the second user computer 6. The web site server computer 8 may send the user code and password to the second user computer 6, via the internet 4, in response to the uploading of the first set of data to the online legal utility computer program running on the web site server computer 8. The user code may be a temporary unique user code. At step 122 the second user (by using the second user computer 6) visits the web site running on the web site server computer 8 and uses the temporary user code, password, and potentially a unique link to the web site to enable the second user to visit and use the online legal utility computer program on the web site. The second user may access at the online legal utility on the web site, the first set of data. In one embodiment of the present invention, no other user or visitor to the web site (other than the first and the second user) is able to access the first set of data on the online legal utility computer program without this temporary unique user code and password and/or unique link to the website.

After step 122, shown in FIG. 2A, the flow chart 100 continues in FIG. 2B via node A. Following step 122, step 124, shown in FIG. 2B is executed. At step 124, the second user is asked by the online utility computer program running on the web site of web site server computer 8, whether he or she accepts terms for a legal relationship that the first user has specified including in one embodiment of the present invention a confidential and/or non-disclosure agreement with respect to the first set of data uploaded to the online legal utility computer program by the first user at step 116. The request for acceptance of legal terms may be supplied from the web site server computer 8 to the second user computer 6 via the internet 4. If the second user does not accept the terms, then no relationship is created, as shown by step 126, between the first and the second user and the second user is not allowed access to the first set of data. If the second user accepts the terms, then a legally binding relationship or first agreement is created between the first user and the second user at the time the second user accepts those terms.

In at least one embodiment, the web site and the web site owner are not a party to the agreement, but the online legal utility computer program at the web site facilitates the creation of a contractual relationship between the first user and the second user.

If the second user accepts the terms for a legal relationship then in at least one embodiment the web site server computer 8 sends a digital certificate to each of the first user computer 2 and the second user computer 6 at step 128. The digital signature could also be sent to e-mail addresses of the first user and the second user, which may cause the digital signature to be stored in an e-mail address computer. The digital certificate(s) confirms the existence of the agreement, the date of the agreement and the terms of the agreement between the first user and the second user and the identity of the second user. In an alternative embodiment the confirmation of the terms of the legal relationship between the parties are not by way of digital signature, but simply by a confirmatory email to both the first user and second user, such as to e-mail addresses of the first user and the second user.

The agreement may be stored in computer memory after it has been entered into and an indication that the first user and the second user have entered into the agreement may also be stored in the computer memory. The computer memory, in which the agreement and the indication that the first user and the second user have entered into the agreement may be stored, may be located on the web site server computer. The identities of the first and the second user, such as their names or social security numbers, or some other user identity indication may be stored in computer memory as an indication or indications that the first and the second user have entered into the agreement. By storing the agreement and indication(s) of the first user and the second user, the web site or web site server acts as a third party witness to an agreement between the first and the second users.

At step 130, after the agreement between the first user and the second user has been created, the second user may access the first set of data via the second user computer 6, or potentially any other computer if, in one embodiment, the second user has the correct temporary username and password and the first user and the second user may subsequently enter into further agreements or contractual relationships via the internet 4 that will be entered into other than via the web site or the utility. In the future, there will be functionality for the first user and the second user to enter into online license agreements and other relationships via the website; for example, say for the commercial use of a piece of library music written and owned or controlled by the first user. As an example, the first user would upload the piece of music to the website. If the second user thought the piece of music was good, the second user would complete certain details on the second user computer 6 (or potentially another computer) about his or her proposed use (e.g. the soundtrack to a TV ad that the second user is making), the media (e.g. showing on TV/non-downloadable internet), and the term (e.g. six months) and territory (e.g. United Kingdom and the United States of America (US). The web site, or web site server computer 8, would calculate the fee for that use according to pre-determined formulae entered into the web site or web site server computer 8 to calculate the library music license value, create an agreement between the first user and the second user on this basis incorporating the correct details and then the website or web site server computer 8 or owner of the web site, as agent/broker would collect the fee from the second user or second user computer 6 and account to the first user or first user computer 2 less its agency/brokerage commission.

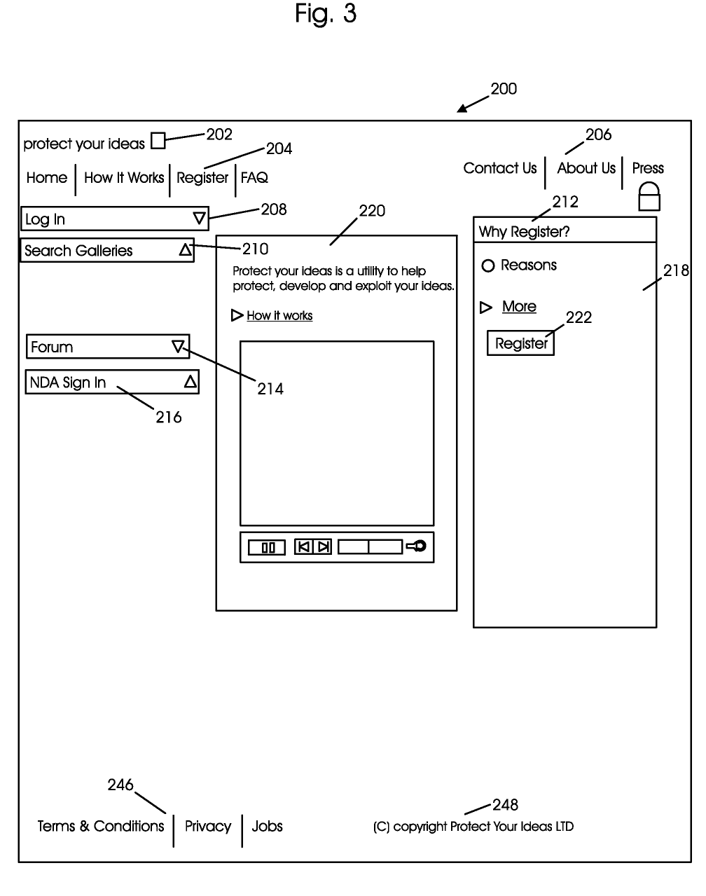

FIG. 3 shows a diagram of a first image 200 which may be displayed on a computer monitor of a user computer, such as the first user computer 2 or second user computer 6 of FIG. 1 in response to the first user or the second user, respectively, entering a web site address into an interactive device, such as a computer keyboard, of the first user computer 2 or the second user computer 6, respectively Each of the first user computer 2 and the second user computer 6 may include a computer monitor or display, a computer memory, an interactive device (such as a keyboard and/or computer mouse), and a computer processor.

The first image 200 may be a home page of a web site. The image 200 includes a field 202 which may identify a name of a web site, such as “protect your ideas”. The image 200 also includes a field 204 which includes links “Home”, “How it Works”, “Register”, and “FAQ”. A user may use a computer cursor operated by a computer mouse of an interactive device of the first user computer 2 or the second user computer 6 to select and/or click on the links of field 204. Clicking on the “Home” link causes a home page to be displayed on a computer monitor of the first user computer 2 or the second user computer 6 depending on which computer is being operated at the time. I.e. if a computer monitor and computer mouse of the first user computer 2 is being operated then clicking on the “Home” link causes the home page to be displayed on the computer monitor of the first user computer 2, but not the second user computer 6. Clicking on the “How it Works” link causes a description of how the web site works to be displayed on a computer monitor of the first user computer 2 or the second user computer 6, again depending on which computer is being operated. Clicking on the “Register” link causes a register page to come up on the computer monitor of the first user computer 2 or the second user computer 6 (again depending on which computer is being operated), allowing the first user or the second user to register as a member on the website. Clicking on the “FAQ” link causes a set of information to be displayed with answers on the appropriate computer monitor of the appropriate computer to common questions concerning the web site.

The image 200 also includes field 210 which refers to “Search Galleries”. The field 210 includes a triangle which when clicked on displays an entry field for entering a search term, not shown, to start a search of sets of data or works that have been uploaded by users of the web site who have registered as members of the web site and which may be viewed or accessed by the first user, the second user and/or other users of the web site. The image 200 further includes a field 214 for “Forum” and a triangle which when clicked on pulls down fields, not shown, inviting users to start a new topic or to go to the forum.

The image 200 also includes field 246 which includes links to various information pages of the web site which can be displayed on the computer monitor which is being operated, including “Terms & Conditions”, “Privacy”, and “Jobs”. The image 200 may also include field 248, which is a copyright notice. Field 206 also provides “Contact Us”, “About Us”, and “Press” links which provide information concerning the web site or its owners.

The image 200 further includes field 212, which when clicked on causes information to be displayed on the computer monitor being operated concerning why someone should register on the web site including the benefit that someone registering as a member will be entitled to use the online legal utility computer program with respect to their works, such as copyrighted works. Field 218 is provided to display further information on the computer monitor being operated concerning why someone should register on the web site. Field 222 is a link to the registration page where someone can register on the web site.

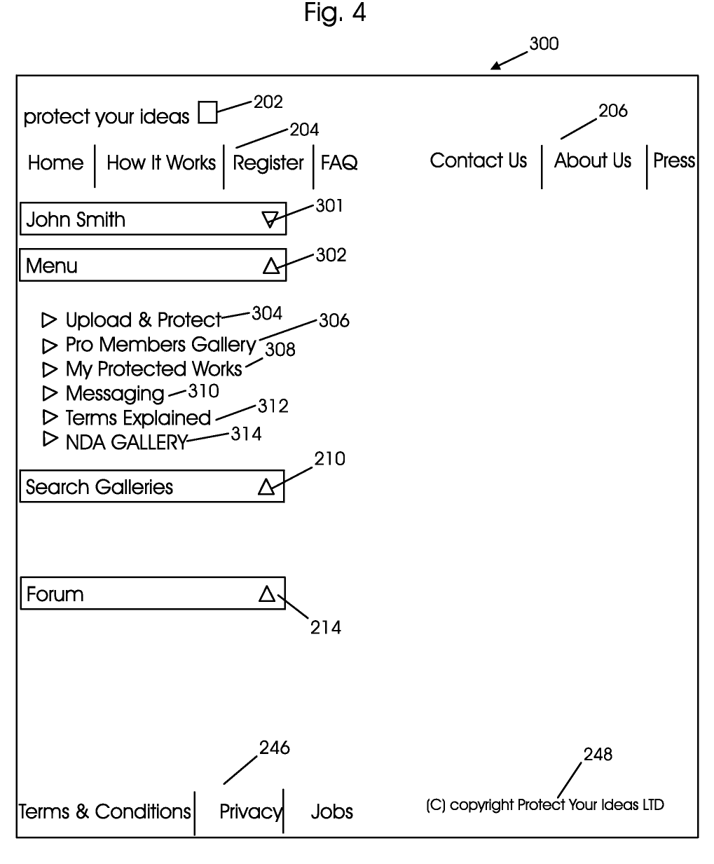

FIG. 4 shows a diagram of a second image 300 which may be displayed on a computer monitor of a user computer, such as the first user computer 2 of a first user but may not be displayed on a computer of a second user, such as second user computer 6 of FIG. 1.

The second image 300 shows a website as it appears on the computer monitor of the first user computer 2, after a first user who may be operating first user computer 2, has become a member of the website as referred to in step 112 of FIG. 2, but before uploading the first set of data at step 114 shown in FIG. 2. In one embodiment of the present invention, only the first user (who is providing the first set of data) needs to be a member of the website to operate a utility triggered by selecting, such as by clicking with a computer mouse of computer 2, the “Upload & Protect” field or link 304 shown in FIG. 4. In at least one embodiment, a second user, such as at a second user computer 6, who receives a temporary username and password to access the first user's first set of data or work does not have to be a member of the web site.

The field or menu item 304 “Upload & Protect”, activates a function on the web site server computer 8 that enables the first user through first user computer 2 to upload the first set of data to the website or web site server computer 8, as referred to in step 114 of FIG. 2.

The image 300 also includes a field 301 which identifies a name, in this case “John Smith” of the first user who is currently using the web site. The field 301 includes an inverted triangle which can be clicked on with a computer cursor using a computer mouse of the first user computer 2 to pull down a description of the person's or first user's membership of the web site.

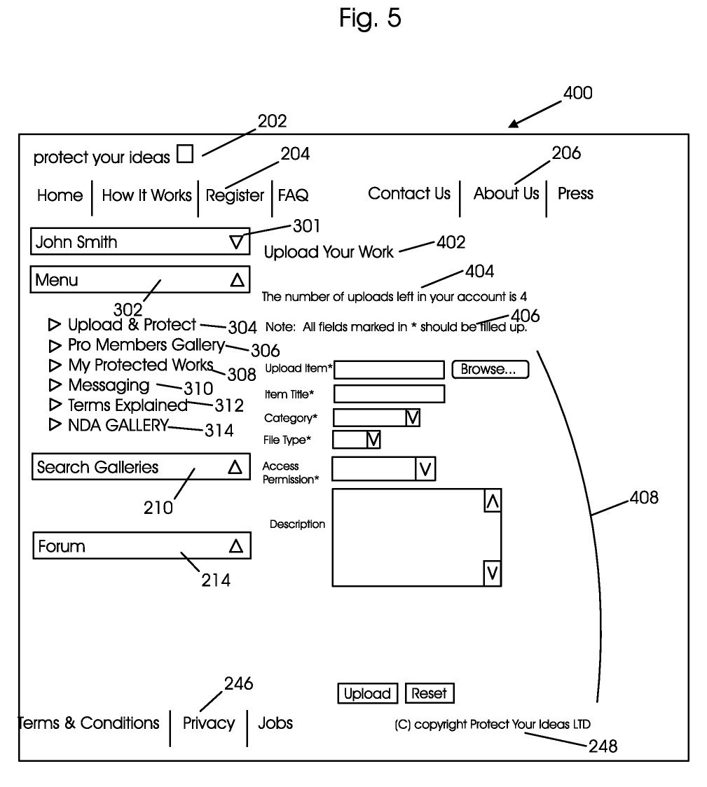

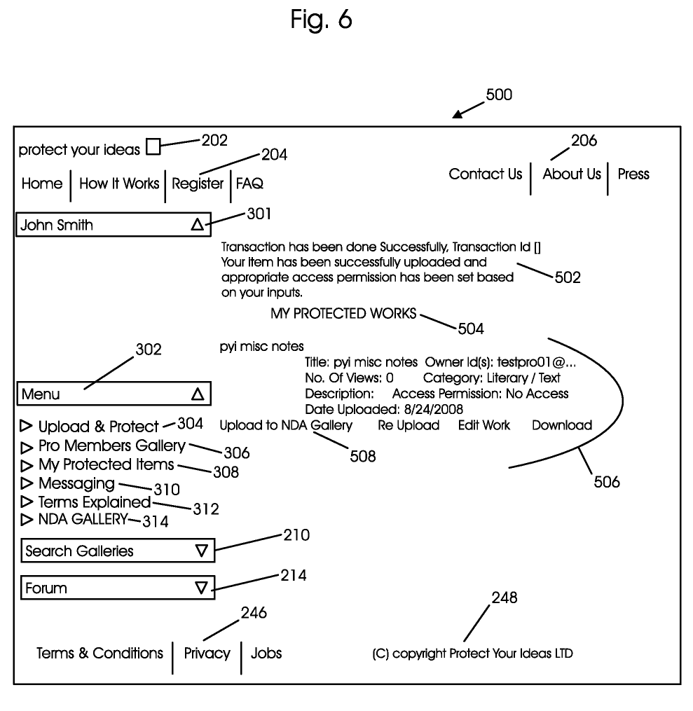

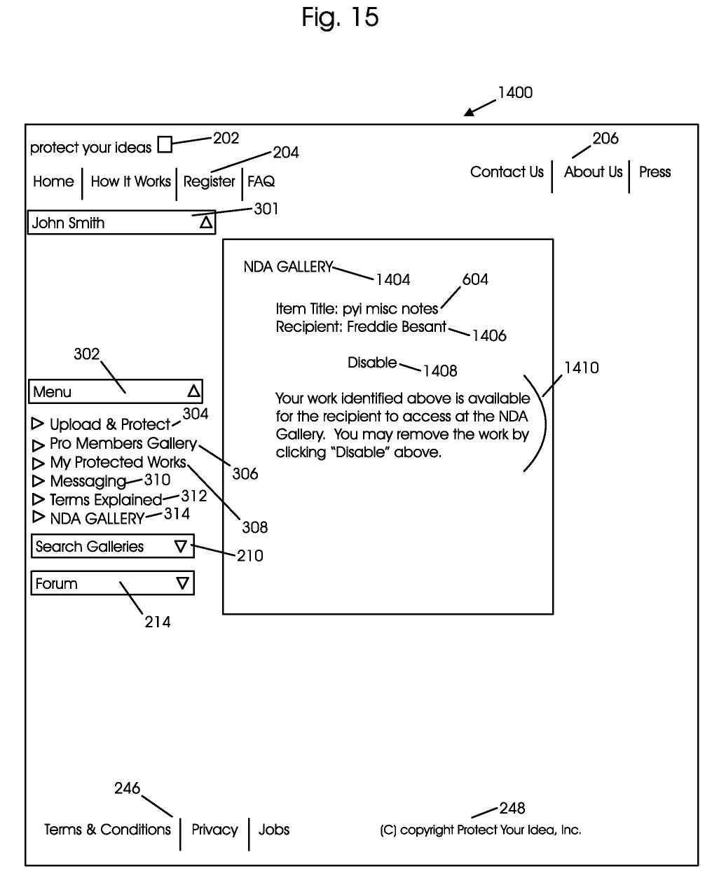

The image 300 also includes a field 302 which describes the “Menu” category. The field 302 includes a triangle which can be clicked on to pull down menu items 304, 306, 308, 310, 312, and 314. Menu item 304 refers to “Upload & Protect” and when clicked on, on the first user computer 2 causes image 400 shown in FIG. 5 to appear on a computer monitor of the first user computer 2. Menu item 306 refers to “Pro Members Gallery” and when clicked on, on the first user computer 2 displays files and/or works embodying data and/or information that have been uploaded by other registered members of the web site, not shown on the computer monitor of the first user computer 2. Menu item 308 refers to “My Protected Works” and when clicked on, on the first user computer 2, causes image 500 shown in FIG. 6 to appear on a computer monitor of the first user computer 2. Menu item 310 refers to “Messaging” and when clicked on, on the first user computer 2 causes a messaging screen, not shown, to appear on the computer monitor of the first user computer 2. Menu item 312 refers to “Terms Explained” and when clicked on, on the first user computer 2, causes an image, not shown to be displayed which explains various terms and conditions used by other web sites inviting users to upload works and content. Menu item 314 refers to “NDA Gallery” and when clicked on, on the first user computer 2, causes image 1400 shown in FIG. 15 to appear on a computer monitor of the first user computer 2. FIG. 4 shows fields 202, 204, 206, 210, 214, 246 and 248 which were previously described with reference to FIG. 3.

FIG. 5 shows a diagram of a third image 400 which may be displayed on the computer monitor of the first user computer 2. The third image 400 may be displayed in response to clicking on the “Upload & Protect” link or field 304. FIG. 4 shows fields 202, 204, 206, 210, 214, 246, and 248 which were previously described with reference to FIG. 3, and also fields 301, 302, 304, 306, 308, 310, 312 and 314 which were previously described with reference to FIG. 4.

The third image 400, shown in FIG. 5, also includes field 402, which has the title or designation of “Upload Your Work”. The third image 400 further includes field 404 which identifies how many sets of data (such as files, documents, works, or items) can be uploaded based on what type of account has been selected or purchased by the first user and the number of sets of data that have already been uploaded. Field 406 is also provided with a designation indicating that fields marked “*” should be filled in by an individual, i.e. information that needs to be entered into the particular user computer, such as first user computer 2 by the first user, using a computer mouse and/or keyboard, into computer memory of the first user computer 2.

Field 408 shows various information concerning the set of data or item (such as files, documents, or works) to be uploaded. The term “work” in field 402 and “item” in field 408 are synonymous and refer to the set of data to be uploaded to the web site server computer 8. There is an entry field or box to the left of a “Browse” field and to the right of “Upload Item*” in field 408. When the “Browse” field is clicked on, the first user can browse for files or items to upload from the first user computer 2. The item or file title can be entered into the first user computer 2, by the first user, into the entry field or box to the right of “Item Title*” in field 408. “Category”, “File Type”, “Access Permission”, and “Description”, for the particular item or file (or set of data) can be entered in entry boxes or field to the right of those designations in field 408 in FIG. 4.

Field 408 also includes “Upload” and “Reset” fields. The “Upload” field can be clicked on to upload the information or set of data just entered in the overall field 408 from the first user computer 2 to the web site server computer 8, via communications link 2a or 6a, the internet 4, and communications link 8a and the “Reset” field can be clicked on to reset the information entered in the entry boxes in field 408.

The image 400 reflects a page of a website in accordance with an embodiment of the present invention as it appears to a first user, such as at the first user computer 2, about to upload a set of data or work to the website server computer 8 and having clicked the “Upload and Protect” link or field 304 shown in FIG. 4. In accordance with an embodiment of the present invention, it is typically not the second user computer 6 that would see this image, but only the first user computer 2 as it is the first user who uploads the first set of data and alerts the second user or second user computer 6 to access it via the online legal utility, in accordance with an embodiment of the present invention.

The first user, such as at first user computer 2, uploads a first set of data or a work (as described in FIG. 2, step 114), by clicking on “Browse” to the right of the box to the right of “Upload Item*” in field 408 shown in FIG. 5, and selecting a computer file in the box next to the text “Upload Item”, giving the file a title by entering a title into the box to the right of “Item Title*”, defining a category by selecting a category from the box to the right of “Category”, and in one embodiment of the present invention, if the first user intends to use the online legal utility at the website in order to create a confidential non-disclosure relationship with the second user, the first user, at the first user computer 2 should then click “No Access” from the box to the right of “Access Permission” when invited to choose under the Access Permission field (all within field 408). The first user, such as at first user computer 2, may be uploading a first set of data such as a copyrighted work and in one embodiment of the present invention will receive a digital signature by e-mail to the first user's e-mail address confirming that the first user has registered the work at the website or web site server computer 8 on the date it is uploaded for future reference and protection. By clicking on “No Access” in the box to the right of “Access Permission*”, the set of data or work will not be able to be viewed on the website by anyone. If the first user had clicked on “Open Access” in the box to the right of Access Permission*, the set of data or work would then be available through the “Galleries” function on the website or web site server computer 8 such that it can be accessed by clicking on the triangle in the search galleries field 210 shown in FIG. 4 or FIG. 5, and then selecting the set of data or work from a list of sets of data or works which will be displayed. If the first user had clicked on “Pro Members Access” in the box to the right of Access Permission*, the set of data or work would then be available through the “Pro Members Gallery” function on the website or web site server computer 8 such that it can be accessed by other registered members of the web site by clicking on the Pro Members Gallery field 306 shown in FIGS. 3-6, and then selecting the set of data or work from a list of sets of data or works which will be displayed.

Once the first User clicks the “Upload” field shown at the bottom in field 408 in FIG. 5, the first set of data or work will become a protected work and will appear under or may be accessed by clicking on the first user's “My Protected Works” field 308 shown in FIGS. 3-6.

FIG. 6 shows a diagram of a fourth image 500 which may be displayed on a computer monitor of the first user computer 2, of the apparatus 1 of FIG. 1. The image 500 may be displayed on the computer monitor of the first user computer 2, in response to the first user, such as at first user computer 2, clicking the “Upload” field shown at the bottom in field 408 in FIG. 5 (as described in FIG. 2, step 114) or clicking on the “My Protected Works” field or link 308 shown in FIG. 4. The image 500 includes one or more fields such as previously described with reference to FIG. 4. The fourth image 500 reflects a website in accordance with an embodiment of the present invention as it appears to a first user, such as at a first user computer 2, who has uploaded a first set of data, file or work and clicked the “My Protected Works” field 308 shown in FIG. 4. The image of the first set of data, file, or work, is referred to as “pyi misc notes” in field 506 of FIG. 6. A first user, such as at the first user computer 2, will see that in the bottom left hand corner of an uploaded item will be a function 508 referred to as “Upload to NDA Gallery”, such as shown in field 506 of FIG. 6. The field or function 508 “Upload to NDA Gallery” activates an online legal utility computer program in accordance with an embodiment of the present invention. In one embodiment of the present invention when a first user such as at the first user computer 2, clicks on this function 508, “Upload to NDA Gallery” in field 506 of FIG. 6, the first user will be able to upload the work to the online legal utility (as per step 116 on FIG. 2) and the web site or the web site server computer 8 prompted by the operation of the legal utility computer program will alert the second user (as per step 118 on FIG. 2) via e-mail, online, and/or digitally that the first user wishes to create a confidential non-disclosure relationship with the second user and if the second user visits the web site the second user may enter into a non-disclosure agreement with the first user in connection with the first set of data in order for the second user to be able to access the first set of data at the web site or the web site server computer 8.

FIG. 6 shows a diagram of an image 500 which may be displayed on a computer monitor of the first user computer 2 of the apparatus 1. The image 500 includes fields 202, 204, 206, 210, 214, 246, and 248 which were explained with reference to FIG. 3. The image 500 also includes fields 301, 302, 304, 306, 308, 310 312 and 314 which were previously described with reference to FIG. 4.

The image 500 in FIG. 6 additionally includes field 502 which is text which indicates that in response to the first user, such as at first user computer 2, clicking the “Upload” field shown at the bottom in field 408 in FIG. 5 the upload transaction has been successful, a transaction identification, and that the item has been successfully uploaded and appropriate access permission has been set based on the first user's inputs. The term “work” in fields 504 and 506 and “item” in field 502 are synonymous and refer to the set of data uploaded to the web site server computer 8. Field 504 is a heading indicating “My Protected Works”. Field 506 provides descriptive information regarding the item uploaded. The item uploaded in this case is “pyi misc notes”. The title, owner identification, no. of views, category, access permission, date uploaded and a description of the item are provided. In addition field 506 includes links for “Re Upload”, “Edit Work” and “Download”. The “Re Upload” link when clicked on enables the first user, such as at first user computer 2 to re upload a subsequent and/or amended version of the item “pyi misc notes” which the first user earlier uploaded (as described in FIG. 2, step 114) having clicked the “Upload and Protect” link or field 304 shown in FIG. 4 in accordance with the procedure described in FIG. 5. The “Edit Work” link when clicked on enables the first user, such as at first user computer 2 to amend the upload details of the uploaded item “pyi misc notes” (as described in field 408 in FIG. 5) such as the item title, category, description, file type and/or access permission. The “Download” link when clicked on enables the first user, such as at first user computer 2 to download and access the item “pyi misc notes” to the first user computer 2.

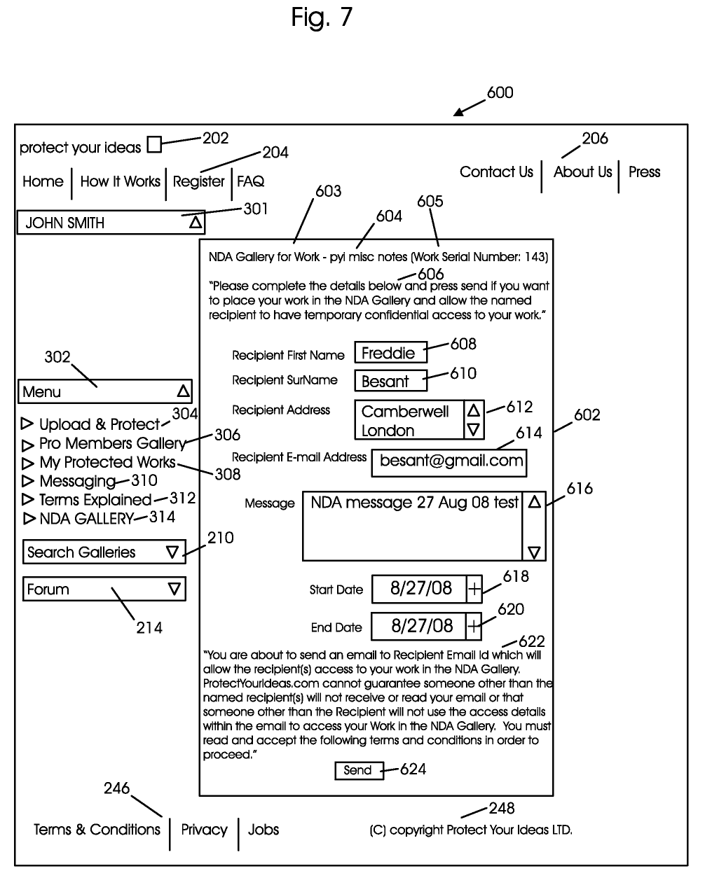

On the website an online legal utility or online legal utility computer program in accordance with at least one embodiment of the present invention is referred to as the “NDA Gallery” (“NDA” standing for non-disclosure agreement) and having clicked “Upload to NDA Gallery” shown at link 508 in field 506 of FIG. 6, the first user will arrive at a web page or image 600 as shown in FIG. 7 (i.e. the image 600 will be displayed on a computer monitor of the first user computer 2).

FIG. 7 shows a diagram of a fifth image 600 which may be displayed on a computer monitor of the first user computer 2 of the apparatus 1 of FIG. 1. The image 600 includes fields 202, 204, 206, 210, 214, 246, and 248 which were explained with reference to FIG. 3. The image 600 also includes fields 301, 302, 304, 306, 308, 310, 312 and 314 which were previously explained with reference to FIG. 4.

FIG. 7 also includes the window 602. The window 602 includes field 603 which shows a heading for “NDA Gallery for Work” and states a title of a work “pyi misc notes” in field 604 and a work serial number which is “143” in field 605. The window 602 also includes a field 606 including text for directions for placing a work in the NDA (non-disclosure agreement) Gallery and to allow a named recipient to have temporary confidential access to the work. The window 602 also includes fields 608, 610, 612, 614, and 616 which provide entry boxes and related text for entering a recipient first name, surname, address, e-mail address, and a message to a recipient, respectively. The fields 618 and 620 provide start date and end date, respectively, for the period during which a recipient will be allowed access to a work. The window 602 also includes field 622 which concerns various terms and conditions, and field 624 which can be clicked on to upload the particular work to the NDA Gallery on the web site and send an email to the particular recipient identified in fields 608, 610, 612, and 614.

At the web page shown in image 600 on the first user computer 2, the first user may enter the details of the second user, referred to on that web page in image 600 as the recipient in the window 602, including at least at fields 608, 610, 612, and 614, and this is the process that will alert the second user (i.e. the recipient) to the offer to enter into a non-disclosure agreement with the first user in connection with the first set of data and ultimately for the second user to access the work in question via the online legal utility and the website. The first user at the first user computer 2 (using an interactive device of the first user computer 2, such as a computer mouse and/or keyboard) completes the fields shown in image 600 in FIG. 7 including the second user's (recipient) first name and surname, address, email address and any message from the first user to the second user (recipient) together with the period (start date through end date shown in fields 618 and 620, respectively), during which the second user may access the work in question and then, after accepting the web site terms and conditions shown in field 622, the first user presses the button “Send” in field 624 for the email to be sent to the second user or recipient. The online legal utility computer program at the website or web site computer server 8 then automatically uploads or places the first set of data, file or work in the NDA Gallery where the second user may access it and sends an email to the second user or recipient, such as to second user computer 6 (as per step 118 in FIG. 2). In one embodiment of the present invention the web site server computer 8 sends an encrypted email to the second user or recipient when the first user clicks the button “Send” in field 624.

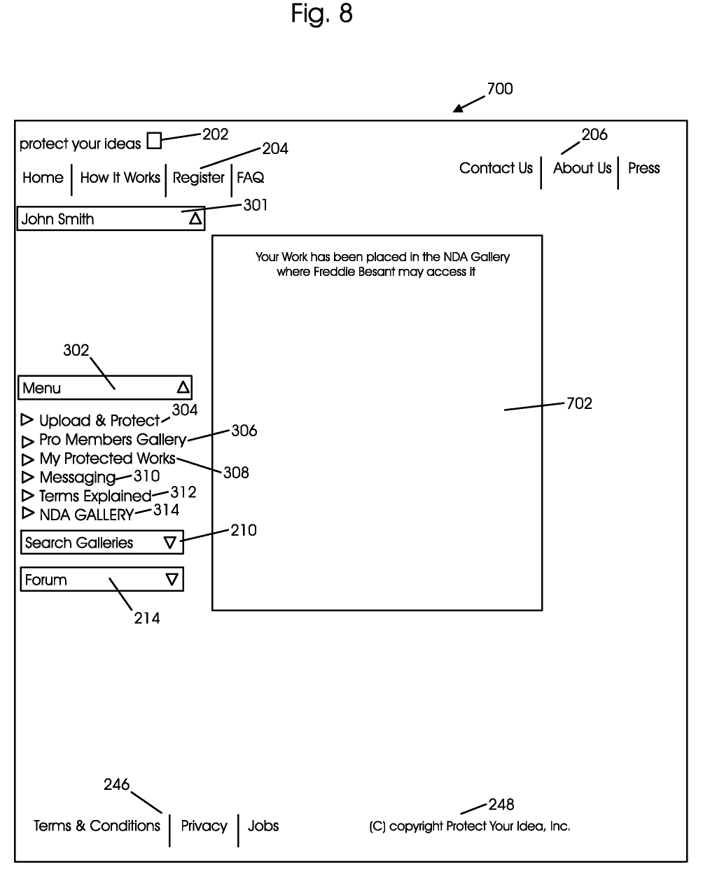

Once the first user at first user computer 2 has pressed or clicked on “Send” shown in field 624 of FIG. 7, the first user will arrive at a web page reflected in the sixth image 700 on the web site (i.e. the image 700 will be displayed on the computer monitor of the first user computer 2) shown in FIG. 8. confirming that the email has been sent to the second user or recipient and that the work and the first set of data have been placed in the “NDA Gallery” for the second user or recipient to access. The sixth image 700 reflects a website in accordance with an embodiment of the present invention as it appears to a first user, such as at a first user computer 2, who has uploaded a first set of data, file or work to the NDA Gallery at the online legal utility and clicked on “Send” shown in field 624 of FIG. 7. The first user will also receive an email, not shown to an e-mail address of the first user that would have been entered during the registration process by the first user to become a member of the web site at step 112 in FIG. 2 from the web site computer server 8 confirming that the first set of data, file or work in question has been placed in the NDA Gallery where the second user may access it if the second user enters into a binding legal relationship with the first user such as a confidential relationship by accepting the terms of a non-disclosure agreement with the first user.

FIG. 8 shows a diagram of an image 700 which may be displayed on a computer monitor of the first user computer 2 of the apparatus 1 of FIG. 1. The image 700 includes fields 202, 204, 206, 210, 214, 246, and 248 previously described with reference to FIG. 3, and fields 301, 302, 304, 306, 308, 310, 312 and 314 which were previously described with reference to FIG. 4.

The image 700 also includes field 702 which shows a confirmation text message that appears to the first user such as at first user computer 2 after the “Send” button or field 624 in FIG. 7 is clicked on by the first user. The message in field 702 indicates that the online legal utility computer program has been activated and the first user's work has been placed in the NDA Gallery where “Freddie Besant”, the intended recipient, can access the work at the web site.

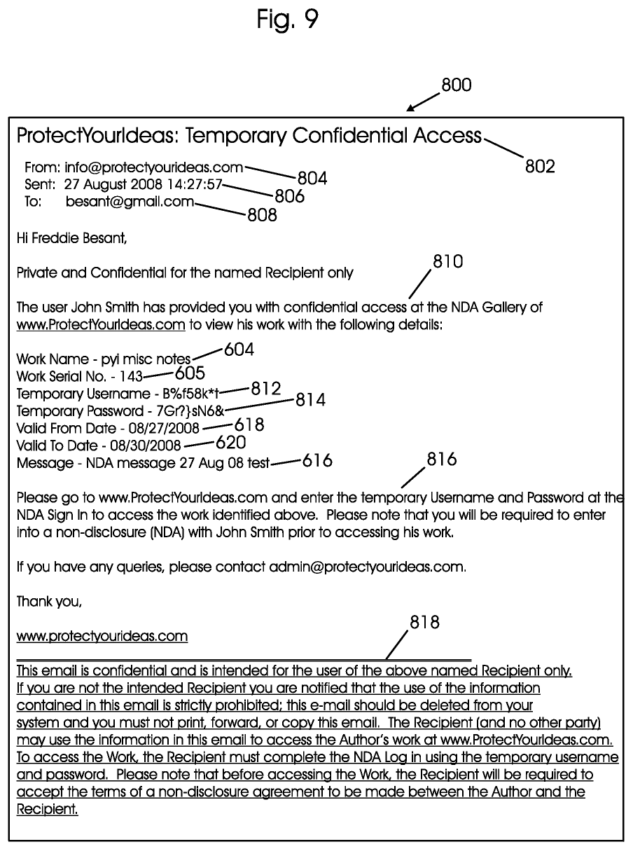

In FIG. 2 step 118 the website or web site computer server 8 sends an email to the second user or recipient, such as to second user computer 6 and at step 120 in FIG. 2 the second user (recipient) will then receive an email such as at the second user computer 6 with a temporary username and a temporary password as shown in seventh image 800 of FIG. 9. In one embodiment of the present invention the image 800 will be displayed on a computer monitor of the second user (recipient) such as at second user computer 6 in response to the second user opening an email received from the web site or the web site computer server 8 in accordance with step 120 in FIG. 2. FIG. 9 shows a diagram of an image 800 which may be displayed on a computer monitor of a second user computer 6 of the apparatus 1. The image 800 includes fields 604, 605, 618, and 620 previously described with reference to FIG. 7. The image 800 also includes fields 802, 804, 806, 808, 810, 812, 814, 816, and 818. The image 800 shows an email that a second user (recipient) receives from the web site or web site computer server 8 as referred to in step 120 of FIG. 2 and includes field 802 which shows a heading for the second user to have “Temporary Confidential Access” to the work or item described in the email. The window 804 states that the email has come from the web site or web site computer server 8 and the window 806 shows the date of sending. The window 808 states the email address of the second user (recipient) and the field 810 includes text with directions to the second user to confirm that the first user has placed the first set of data, file or work in the NDA (non-disclosure agreement) Gallery at the web site and that the second user (recipient) has temporary confidential access to the work. The image 800 shows the identifying details of the work and states a title of a work “pyi misc notes” in field 604 and a work serial number which is “143” in field 605 together with the period (start date through end date shown in fields 618 and 620, respectively), during which the second user may access the work in question.

The image 800 at FIG. 9 also includes fields 812 and 814 which provide the second user (recipient) with a temporary username and a temporary password, respectively and a text field 816 inviting the second user to visit the web site where the temporary username and temporary password can be entered at the NDA Sign In shown in field 216 in FIG. 2 by the second user to access the first user's work subject to the second user (recipient) entering into a confidential relationship by accepting a non-disclosure agreement with the first user before accessing the first user's work. The image 800 also includes a text field 818 informing the second user (recipient) and any other user or individual viewing the email addressed to the second user (recipient) that it is confidential and intended for the use of the named recipient only and that use of the information in the email shown in image 800 by anyone other than the named recipient is prohibited.

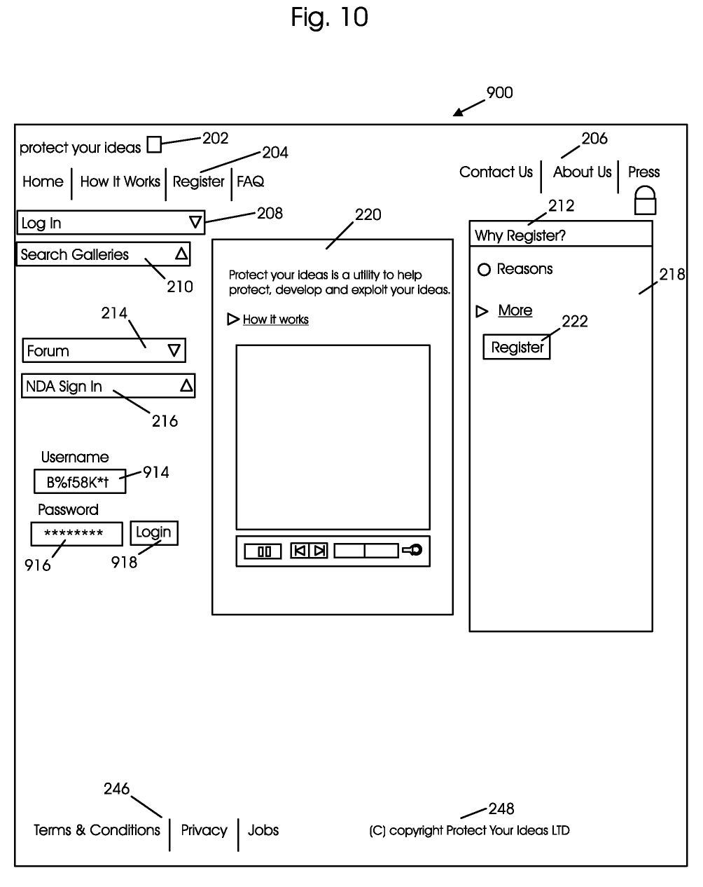

The second user (recipient) then goes to the home page of the website as shown in image 900 of FIG. 10 (which is displayed on the computer monitor of the second user computer 6).

FIG. 10 shows a diagram of an image 900 which may be displayed on a computer monitor of a second user computer 6 of the apparatus 1 in response to the second user entering the web site address into an interactive device, such as a computer keyboard, of the second user computer 6. The image 900 includes fields 202, 204, 206, 208, 210, 212, 214, 216, 218, 220, 222, 246, and 248 which have been previously described with reference to FIG. 3. The image 900 also includes fields 914, 916, and 918. Fields 914 and 916 allow a second user (recipient) to enter a temporary unique user name and temporary password respectively for enabling the second user (recipient) to log in and use the online legal utility computer program to create a confidential relationship by entering into a non-disclosure agreement with the first user in order to access the first user's work. Field 918 can be clicked on to login once the temporary username and password have been entered by the second user (recipient) at fields 914 and 916 respectively.

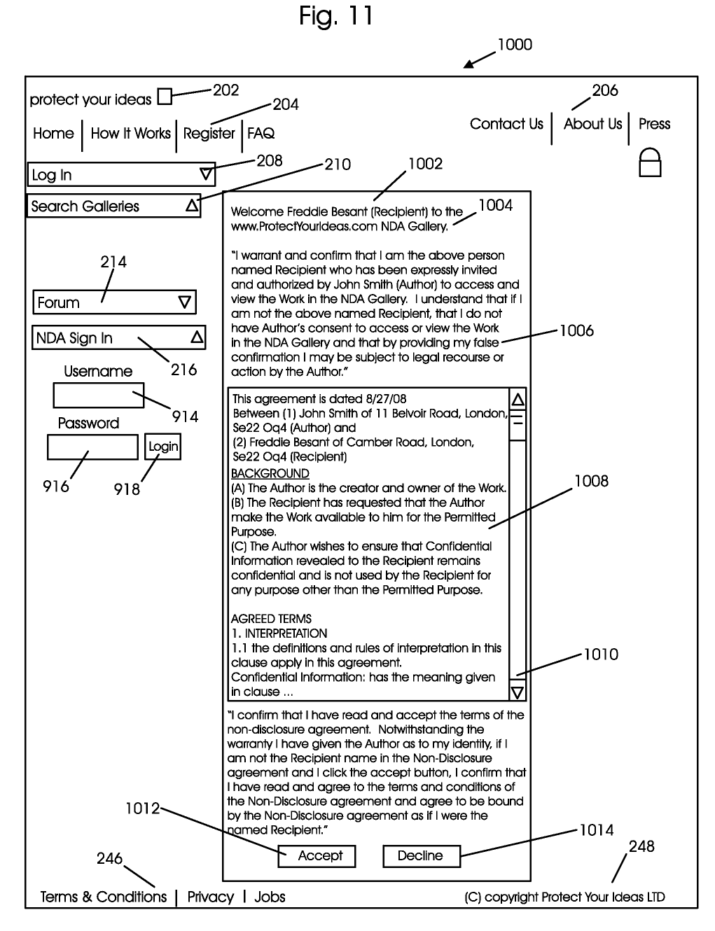

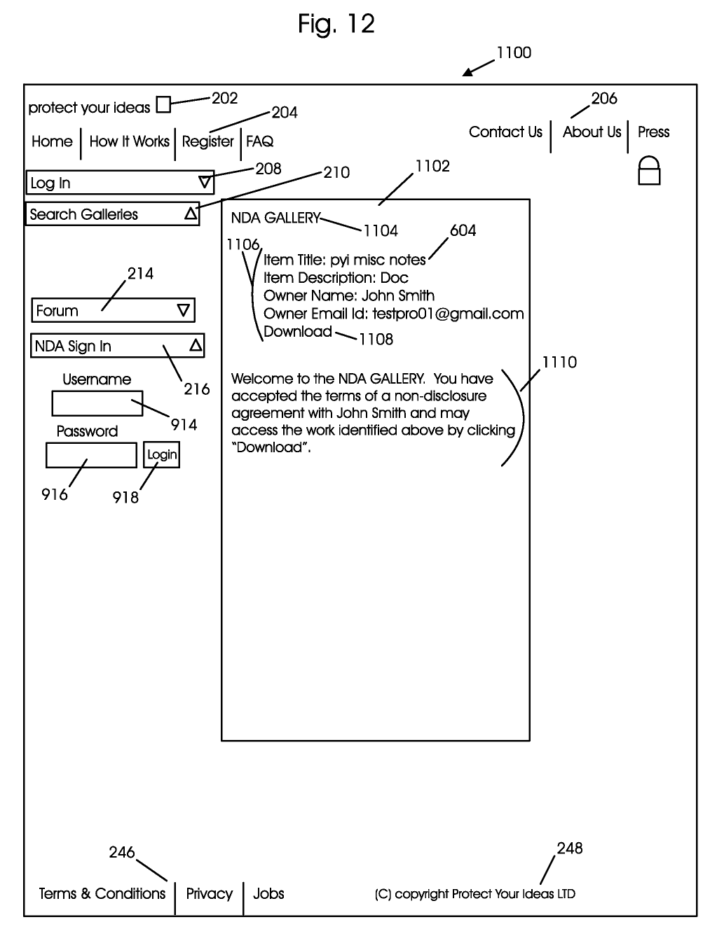

In one embodiment of the present invention the web site includes a field 216 which refers to NDA Sign In. The field 216 includes a triangle which when clicked on displays the entry fields 914 and 916 where the second user can enter the temporary username (into field 914) and password (into field 916) on the second user computer 6 on a page (image 900 shown in FIG. 10) which refers to “NDA Sign In” in field 216. If having entered the temporary username into field 914 and password into field 916 using a computer mouse and/or keyboard of the second user computer 6, the second user clicks on Log In at field 918 shown in FIG. 10, at the second user computer 6, using an interactive device of the second user computer 6, the second user will arrive at the NDA Gallery function (i.e. that function will be displayed on the computer monitor of the second user computer 6) that requires the second user to accept the terms of the legal relationship referred to at step 124 in FIG. 2. and shown in field 1000 of FIG. 11. If the second user clicks “Decline” in field 1014 of image 1000 of FIG. 11 on the second user computer 6, no legal relationship will be created in accordance with step 126 in FIG. 2, but if the second user clicks “Accept” in field 1012 on the second user computer 6 then the second user will enter into a confidentiality agreement with the first user (not the website) whereby the second user (recipient) can access the work or set of data in question as shown in image 1100 of FIG. 12.

FIG. 11 shows a diagram of a ninth image 1000 which may be displayed on a computer monitor of the second user (recipient) computer 6 of the apparatus 1. The image 1000 includes fields 202, 204, 206, 208, 210, 214, 216, 246, and 248 which have been previously described with reference to FIG. 3, and fields 914, 916, and 918, previously described with reference to FIG. 10. The image 1000 reflects a website in accordance with an embodiment of the present invention as it appears to a second user, such as at a second user computer 6, who has entered the temporary username into field 914 and password into field 916 and clicked on Log In at field 918 shown in FIG. 10. The image 1000 includes a window 1002 which includes a welcoming text field 1004, a warranty text field 1006, the terms of a non-disclosure agreement in text field 1008, and a confirmation text field 1010.

The non-disclosure agreement in text field 1008 is between the first user who uploaded the first set of data to the online legal utility at the website at step 116 in FIG. 2 and the second user (recipient) who has entered the temporary unique username and password at fields 914 and 916 respectively in FIG. 10 and will be dated on the date that the second user (recipient) is visiting the online legal utility at the website. Fields or buttons 1012 and 1014 can be clicked on by a second user (recipient) at first user computer 2 in order to accept or decline, respectively, the terms of the non-disclosure agreement in field 1008. If the second user clicks “Accept” in field 1012 on the second user computer 6 or alternatively another computer then the second user will enter into a confidentiality agreement with the first user (not the website) whereby the second user (recipient) can access the first user's first set of data, file or work in question as shown in image 1100 of FIG. 12.

The field or function 1012 “Accept” activates the online legal utility computer program in accordance with an embodiment of the present invention to create a binding confidential relationship between the first user and the second user in respect of the first user's first set of data, file or work. In one embodiment of the present invention when a second user such as at the second user computer 6, clicks on this function 1012, “Accept”, (as per step 124 on FIG. 2) the online legal utility and the web site or the web site server computer 8 prompted by the operation of the legal utility computer program will send a digital signature to both the first user and the second user (as per step 128 on FIG. 2) via e-mail, online, and/or digitally that a confidential non-disclosure relationship has been created between the first user and the second user at the time and date that the second user clicked field or function 1012 “Accept”.

FIG. 12 shows a diagram of an image 1100 which may be displayed on a computer monitor of the second user (recipient) computer 6 of the apparatus 1. The image 1100 includes fields 202, 204, 206, 208, 210, 214, 216, 246, and 248 which have been previously described with reference to FIG. 3, field 604 previously described with reference to FIG. 7 and fields 914, 916, and 918, previously described with reference to FIG. 10. The image 1100 also includes a window 1102 which includes field 1104 which shows a heading for “NDA Gallery” indicates that the online legal utility computer program has operated to allow the second user to use the NDA Gallery and confidential temporary access has been granted to the first user's first set of data, file or work identified in field 1106 with the item title “pyi misc notes” in field 604, a description of the work, the first user (owner of the work) name and e-mail address. In one embodiment of the present invention the second user clicks “Download” at field 1108 in window 1102 in order to access the work and the web site or web site server computer 8 downloads the first set of data, file or work to the second user's computer such as second user computer 6. The window 1102 also includes a text field 1110 with directions for the second user to access the work by clicking the Download function at field 1108 in the NDA Gallery.

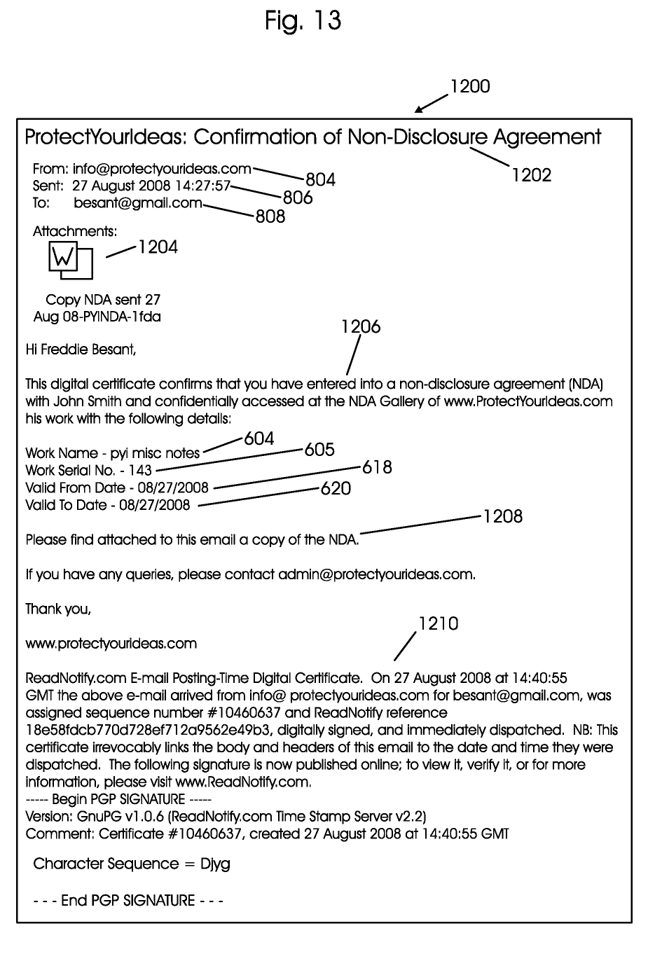

In one embodiment of the present invention the online legal utility computer program prompts the website or web site computer server 8 in accordance with step 128 in FIG. 2 to send an email with a digital signature to the second user or recipient, such as to second user computer 6 confirming the existence of an agreement between the second user and the first user as shown in image 1200 of FIG. 13. The image 1200 will be displayed on a computer monitor of the second user (recipient) such as second user computer 6.

FIG. 13 shows a diagram of an image 1200 which may be displayed on a computer monitor of a second user computer 6 of the apparatus 1. The image 1200 includes fields 604, 605, 618, and 620 previously described with reference to FIG. 7 and also fields 804, 806, and 808 previously described with reference to FIG. 9. The image 1200 shows an email with a digital signature that a second user (recipient) receives from the web site or web site computer server 8 as referred to in step 128 of FIG. 2 and includes field 1202 which shows a heading “Confirmation of Non-Disclosure Agreement”. Field 1204 in image 1200 is an attachment to the email that is a word document or pdf file embodying the terms of the non-disclosure agreement in field 1008 of FIG. 11 that has been entered into by the second user (recipient) with the first user when the second user clicked the “Accept” button 1012 in FIG. 11. The field 1206 includes text confirming to the second user that the second user has entered into the non-disclosure agreement with the first user and confidentially accessed the first user's work in the NDA (non-disclosure agreement) Gallery at the web site. The image 1200 shows the identifying details of the work and states a title of a work “pyi misc notes” in field 604 and a work serial number which is “143” in field 605 together with the period (start date through end date shown in fields 618 and 620, respectively), during which the second user may confidentially access the work in question.

The image 1200 at FIG. 13 also includes a text field 1200 which informs the second user (recipient) that a copy of the non-disclosure agreement entered into by the second user and the first user is attached to the email. The image 1200 also includes a text field 1210 that embodies the digital signature including a sequence number and unique reference to link the email with the content of the email and the non-disclosure agreement attached in field 1204.

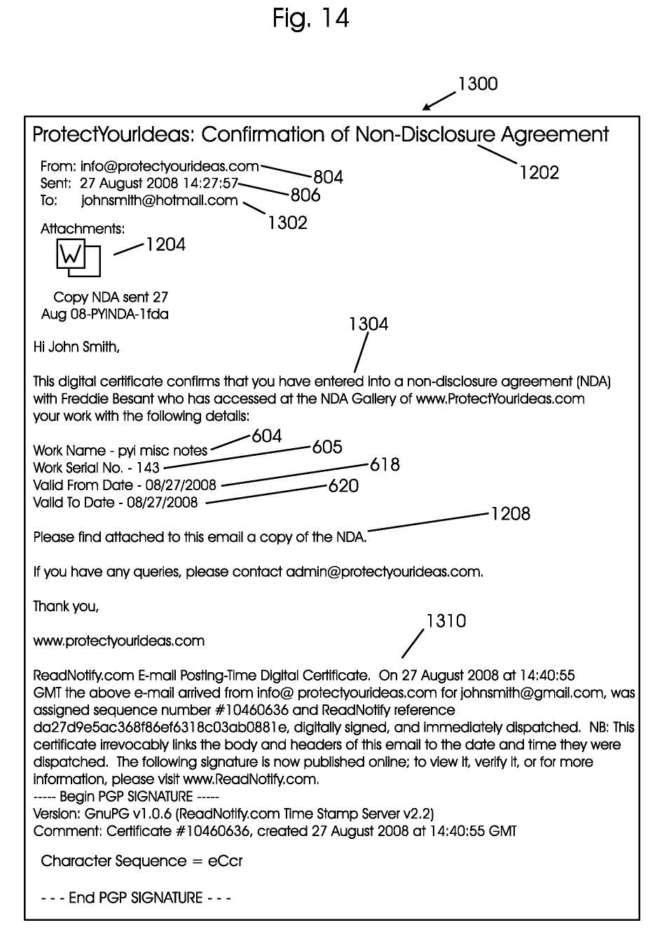

In one embodiment of the present invention the online legal utility computer program prompts the website or web site computer server 8 in accordance with step 128 in FIG. 2 to send an email with a digital signature to the first user, such as to first user computer 2 confirming the existence of an agreement between the first user and the second user as shown in image 1300 of FIG. 14. The image 1300 will be displayed on a computer monitor of the first user such as first user computer 2.

FIG. 14 shows a diagram of an image 1300 which may be displayed on a computer monitor of a first user computer 2 of the apparatus 1. The image 1300 includes fields 604, 605, 618, and 620 previously described with reference to FIG. 7, fields 804 and 806 previously described with reference to FIG. 9 and also fields 1202, 1204, 1208 and 1210 previously described with reference to FIG. 13. The image 1300 shows an email with a digital signature that a first user receives from the web site or web site computer server 8 as referred to in step 128 of FIG. 2 and includes window 1302 which states the email address of the first user. Field 1304 in image 1200 includes text confirming to the first user that the second user has entered into the non-disclosure agreement with the first user and confidentially accessed the first user's work in the NDA (non-disclosure agreement) Gallery at the web site.

In one embodiment of the present invention if a first user such as at the first user computer 2 decides having placed the first set of data in the NDA Gallery that the work should no longer be available for the second user to access and that the first user does not want to create a confidentiality relationship with the second user by entering into a non-disclosure agreement with the second user, the online legal utility computer program may include the option for the first user to remove the work from the NDA Gallery and terminate the second user's ability to access the work. FIG. 15 shows a diagram of an image 1400 which may be displayed on a computer monitor of the first user computer 2 of the apparatus 1 in response to clicking on the “NDA Gallery” link at field 314 of FIG. 4 after the first user at first user computer 2 has pressed or clicked on “Send” shown in field 624 of FIG. 7, and the work and the first set of data have been placed in the “NDA Gallery” for the second user or recipient to access. The image 1400 includes fields 202, 204, 206, 210, 214, 246, and 248 which have been previously described with reference to FIG. 3, fields 301, 302, 304, 306, 308, 310, 312 and 314 which were previously described with reference to FIG. 4, and field 604 previously described with reference to FIG. 7. The image 1400 also includes a window 1402 which includes field 1404 which shows a heading for “NDA Gallery” indicating that the first user's work with the item title “pyi misc notes” in field 604 is in the NDA Gallery and confidential temporary access has been granted to the second user (recipient) identified in field 1406. In one embodiment of the present invention, prior to the second user accessing the first user's first set of data, file or work and prior to entering into the non-disclosure agreement with the first user, if the first user clicks “Disable” at field 1408 in window 1402 the first user may remove the work and ensure that the second user may not access the first set of data, file or work. The window 1402 also includes a text field 1410 with directions for the first user to remove the work by clicking the Disable function at field 1408 in the NDA Gallery.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
configuring a web site server computer so that it runs a computer software program which provides a web site;
configuring the web site so that a first user can become a member of the web site by use of a first user computer;
configuring the web site so that the web site can accept a first set of data uploaded from the first user computer to the web site;
configuring the web site so that it sends an alert from the web site server computer to a second user computer of a second user, wherein the alert specifies that the first set of data can be downloaded to the second user computer if an agreement is entered into between the first user and the second user;
configuring the web site so that it can accept an indication that the agreement has been entered into between the first user and the second user; and
configuring the web site so that if the agreement has been entered into between the first user and the second user, the web site allows the second user to download the first set of data from the web site server computer to the second user computer.

2. The method of claim 1 further comprising
configuring the web site server computer so that the web site server computer sends a digital signature to the first user computer and to the second user computer when the agreement has been entered into.

3. The method of claim 1 wherein
the web site is configured to allow the second user a limited period of time to download the first set of data from the web site server computer to the second user computer.

4. The method of claim 1 wherein
the web site server provides a first user interface to the first user computer; and
wherein the first user can use the first user interface to upload the first set of data to the web site server

5. The method of claim 4 wherein
the first user can use the first user interface to send an offer to the second user;
wherein the offer indicates that the second user can download the first set of data from the web site server if the first user and the second user enter into the agreement.

6. The method of claim 4 wherein
the first user can use the first user interface to disable the upload of the first set of data to the web site server.

7. The method of claim 5 wherein
the first user can use the first user interface to withdraw the offer to enter into the agreement with the second user so that the second user is unable to download the first set of data from the web site server.

8. The method of claim 1 wherein
the web site server provides a second user interface to the second user computer; and
wherein the second user can use the second user interface to enter into the agreement with the first user and to download the first set of data if the agreement is entered into with the first user.

9. The method of claim 1 wherein
the agreement is a confidentiality agreement through which the second user agrees to keep the first set of data confidential.

10. The method of claim 2 wherein
the agreement is a confidentiality agreement through which the second user agrees to keep the first set of data confidential.

11. The method of claim 3 wherein
the agreement is a confidentiality agreement through which the second user agrees to keep the first set of data confidential.

12. The method of claim 4 wherein
the agreement is a confidentiality agreement through which the second user agrees to keep the first set of data confidential.

13. The method of claim 8 wherein
the agreement is a confidentiality agreement through which the second user agrees to keep the first set of data confidential.

14. The method of claim 1 further comprising
storing the agreement after it has been entered into in a computer memory;
and storing an indication that the first user and the second user have entered into the agreement in the computer memory.

15. The method of claim 14 wherein
the computer memory is located on the web site server computer.
